(19) United States
(12) Patent Application Publication
(10) Pub. No.: US 2024/0207794 A1
(43) Pub. Date: Jun. 27, 2024

(54) ASYMMETRIC POLYETHER SULFONE (PES) FILTER MEMBRANE FOR REMOVING VIRUS AND PREPARATION METHOD THEREFOR

(71) Applicant: Hangzhou Cobetter Filtration Equipment Co., Ltd., Hangzhou (CN)

(72) Inventors: Andy Jia, Hangzhou (CN); Albert Lu, Hangzhou (CN)

(21) Appl. No.: 18/602,030

(22) Filed: Mar. 12, 2024

Related U.S. Application Data
(63) Continuation of application No. PCT/CN2022/119073, filed on Sep. 15, 2022.

(30) Foreign Application Priority Data
Sep. 18, 2021 (CN) 202111098240.6

(51) Int. Cl. B01D 71/68; B01D 67/00; B01D 69/02

(52) U.S. Cl. CPC B01D 71/68; B01D 67/0011; B01D 67/0013; B01D 67/0016; B01D 69/02

(57) ABSTRACT

The present disclosure provides an asymmetric PES filter membrane for removing a virus and a preparation method therefor. The PES filter membrane comprises a main body having a non-directional tortuous path therein, one surface of the main body is a first outer surface, and the first outer surface is a large-pore surface; the other surface of the main body is a second outer surface, and the second outer surface is a small-pore surface; the average pore size of the main body continuously changes in a gradient manner from a region on one side close to the first outer surface to a region on one side close to the second outer surface; and the main body comprises a pre-filtering layer and a separation layer for retaining a virus, the other side of the pre-filtering layer and the other side of the separation layer are in transition with a continuous fiber.

### CROSS-REFERENCE TO RELATED APPLICATIONS

The present application is a continuation application of PCT application No. PCT/CN2022/119073 filed on Sep. 15, 2022, which claims the benefit of Chinese Patent Application No. 202111098240.6 filed on Sep. 18, 2021. The contents of all of the aforementioned applications are incorporated by reference herein in their entirety.

### TECHNICAL FIELD

The present disclosure relates to the technical field of membrane materials, and in particular to an asymmetric polyether sulfone (PES) filter membrane for removing a virus and a preparation method therefor.

### BACKGROUND

A membrane technology is a new modern high-efficiency separation technology. Compared with the traditional technologies such as distillation, rectification and the like, the membrane technology has the advantages of high separation efficiency, low energy consumption, small occupied area and the like. The core of the membrane separation technology is a separation membrane. A polymer filter membrane is a separation membrane which is prepared by taking an organic high-molecular polymer as a raw material according to a certain process. With the development of petroleum industry and science and technology, the application field of the polymer filter membrane is continuously expanded. The currently applied fields include gas separation, seawater desalination, ultrapure water preparation, sewage and waste treatment, artificial organ manufacturing, medicines, foods, agriculture, chemical industry and the like.

According to the difference of the types of the high-molecular polymers, the polymer filter membrane can be subdivided into a cellulose polymer filter membrane, a polyamide polymer filter membrane, a sulfone polymer filter membrane, a polytetrafluoroethylene polymer filter membrane and the like. In addition, the membrane may be classified into a microfiltration membrane, an ultrafiltration membrane, a nanofiltration membrane, and a reverse osmosis membrane according to the pore size of the membrane.

In recent years, in addition to a plasma fractionation preparation derived from human blood, measures for improving virus safety are also required for biological drugs. Therefore, pharmaceutical manufacturers have studied the introduction of a virus removal/inactivation step into the manufacturing process. A virus removal method in which filtration is performed using a virus removal membrane is effective and capable of reducing viruses without denaturing useful proteins.

For example, Chinese patent CN1759924B (applied by EMD Millipore) discloses a multilayer composite ultrafiltration membrane (FIG. 17). The ultrafiltration membrane comprises at least one first porous membrane layer having a first face and an equivalent second face, and at least one second porous membrane layer having an equivalent first face and a second face. The first layer is superposed with the junction of the second layer and has a porosity junction transition region from the equivalent first face of the second layer to the equivalent second face of the first layer, wherein at least one of the layers is an asymmetric ultrafiltration membrane. The membrane structure formed by the compounding has a stronger retention effect on a parvovirus, and simultaneously can obtain higher protein yield, thereby meeting the requirements of practical application.

However, the composite ultrafiltration membrane can be prepared from at least two different membrane-casting solutions. A compounding process is as follows: co-casting two solutions using a slot die coater (schematic diagram of the device: FIG. 18), adjusting the casting thickness of a first polymer solution to a suitable thickness, adjusting the casting thickness of a second polymer solution to a final layer thickness of 15 microns or about 10% of the whole membrane thickness, and selecting forming conditions such that the first solution is rapidly heated above the cloud point on a casting drum before the solutions are immersed into a water bath at 55° C., while the second solution has not yet reached the cloud point, thereby enabling the first polymer solution to form a microporous layer and the second polymer solution to form an ultrafiltration layer. The preparation of various membrane-casting solutions is relatively complicated, the compounding process is complex, and the economic cost is high, such that the development of virus removal membranes is limited to a certain extent.

### SUMMARY

Aiming at the shortcomings of the prior art, the present disclosure aims to provide an asymmetric PES filter membrane for removing a virus and a preparation method therefor. The PES filter membrane is prepared by only one membrane-casting solution and integrally formed, does not need to be compounded, and has a relatively simple preparation process. Meanwhile, the prepared PES filter membrane has a strong retention effect on a virus, and simultaneously can obtain higher protein yield, thereby meeting the requirements of practical application.

In order to realize the above objectives, the present disclosure provides the following technical solutions: an asymmetric PES filter membrane for removing a virus, comprising a main body having a non-directional tortuous path therein, one surface of the main body being a first outer surface, and the other surface of the main body being a second outer surface, wherein the average pore size of the first outer surface is 150-450 nm, and the average pore size of the second outer surface is 10-42 nm;
the average pore size of the main body continuously changes in a gradient manner from a region on one side close to the first outer surface to a region on one side close to the second outer surface; and
the main body comprises a pre-filtering layer and a separation layer for retaining a virus, one side of the pre-filtering layer is the first outer surface, and one side of the separation layer is the second outer surface; and the other side of the pre-filtering layer and the other side of the separation layer are in transition with a continuous fiber.

In the main body structure of the PES filter membrane provided by the present disclosure, it can be clearly seen that the pore sizes of the pores in the two outer surfaces of the filter membrane are different to a certain extent. The pore size of the pores in one outer surface is larger, the outer surface with the larger pore size is called as the first outer surface in the present disclosure, namely the first outer surface is the large-pore surface of the filter membrane, and the average pore size of the first outer surface is 150-450 nm, preferably, 200-400 nm. The large-pore surface is favorable for improving the overall filtering speed of the membrane, such that the fluid filtering time is shorter and the time cost is lower.

However, the pore size of the pore in pores in the other outer surface of the filter membrane is smaller, and the outer surface with the smaller pore size is called the second outer surface in the present disclosure, namely the second outer surface is a small-pore surface of the filter membrane, the average pore size of the second outer surface is 10-42 nm, preferably, 14-35 nm. The small-pore surface is favorable for improving the filtration precision of the membrane and ensures that the PES filter membrane has a higher retention effect on a parvovirus. The average pore sizes of the first outer surface and the second outer surface are different to a certain extent, indicating that the PES filter membrane is asymmetric, such that the whole membrane has a higher filtering speed, a larger dirt-holding capacity, and a longer service life, and also can ensure a stronger trapping capacity of a parvovirus (particularly the parvovirus with the particle size of about 20 nm), thereby meeting the requirements of practical application.

Besides, through observing the main body structure of the membrane, it is also found that the average pore size of the main body continuously changes in a gradient manner from a region on one side close to the first outer surface to a region on one side close to the second outer surface, namely the average pore size of the main body of the membrane is gradually changed slowly without mutation, thereby proving that the PES filter membrane is integrally formed without processes such as compounding and the like. The whole filter membrane main body of the present disclosure is mainly divided into two regions in the thickness direction, wherein one region is a pre-filtering layer comprising the first outer surface, the pore size of the pores inside is relatively large and the pre-filtering layer is mainly used for retaining large-particle impurities in a fluid and has large dirt-holding capacity and high flow speed; and the other region is a separation layer containing the second outer surface, the pore size of the pores inside is relatively small, and the separation layer is mainly used for retaining fine particle impurities such as a parvovirus in a protein, so as to ensure the filter membrane also has a high virus trapping capacity. Therefore, the PES filter membrane is particularly suitable for virus removal.

Furthermore, the other side of the pre-filtering layer (one side, facing away from the first outer surface, of the pre-filtering layer) and the other side of the separation layer (one side, facing away from the second outer surface, of the separation layer) are in transition with a continuous fiber. It can be understood that “continuous” means that substantially all the fibers are integrally connected to each other, e.g. integrally formed, without the need for an additional bonding agent and the like to interconnect them, and the fibers in the network cannot be separated from each other unless torn by an external force. At the same time, the continuous network-like fibers are interconnected with the first outer surface and the second porous surface. The PES filter membrane is uniform in material at all positions, namely the whole membrane is made of the PES material, and the material is not changed.

In the present disclosure, it should be understood that in the asymmetric membrane, the pre-filtering layer and the separation layer are composed of the same material, and the two layers are combined into one integral structure and are directly formed during the membrane preparation process. In the transition from the pre-filtering layer to the separation layer, there is only a change in the membrane structure. In contrast, for example, a composite membrane has a multilayer structure and is formed by a separate process of applying a dense layer as a separation layer on a porous, frequently microporous, support layer or support membrane. The materials of the support layer and separation layer of the composite membrane are also different.

The measurement mode of the average pore size of the membrane surface comprises performing morphology characterization of the membrane structure by using a scanning electron microscope, performing measurement by using a computer software (such as Matlab, NIS-Elements and the like) or manually, and then performing calculation. In the preparation of the membrane, various characteristics such as the pore size distribution in the direction perpendicular to the thickness of the membrane (the direction is planar if the membrane is in the form of a flat plate; and the direction is perpendicular to the radius if the membrane is in the form of a hollow fiber) are roughly uniform and substantially the same. Therefore, the average pore size of the whole plane can be reflected by the average pore size of a partial region in the corresponding plane. In practice, during the measurement, firstly the surface of the membrane can be characterized by an electron microscope to obtain a corresponding SEM image, and since the pores in the surface of the membrane are substantially uniform, a certain area, such as 1 μm² (1 μm multiplied by 1 μm) or 25 μm² (5 μm multiplied by 5 μm), can be selected, and the specific area size is determined according to actual conditions, then the pore sizes of all pores in the area are measured by the corresponding computer software or manually, and then the average pore size of the surface is obtained by calculation. Of course, those skilled in the art can also obtain the above parameters by other measuring means, and the above measuring means are for reference only.

As a further improvement of the present disclosure, a plurality of first pores in a circular shape are arranged in the first outer surface; and the pore area ratio of the first pores in the first outer surface is 0.1%-15%; and
a plurality of second pores in a circular shape are arranged in the second outer surface; and the pore area ratio of the second pores in the second outer surface is 2%-10%.

In the body structure of the PES filter membrane provided by the present disclosure, it can be clearly seen a certain number of the first pores with a certain pore size in the first outer surface of the membrane. It is well-known that the factors such as the pore size, the number and the shape of the pores of the membrane can generate great influence on the properties such as the filtration precision (retention efficiency) and the flow speed of the membrane. The first pores in the first outer surface are circular, some first pores are round, and some first pores are oval; and the pore area ratio of the first pores in the first outer surface (the ratio of the area of the first pores to that of the membrane) is 0.1%-15%. Meanwhile, it can also been seen that a certain number of the second pores with a certain pore size in the second outer surface of the membrane. The second pores in the second outer surface are also circular, some second pores are circular, and some second pores are oval; and the pore area ratio of the second pores in the second outer surface (the ratio of the area of the second pores to that of the membrane) is 2%-10%. Under the mutual synergistic effect between the pore area ratio of the first pores in the first outer surface and the pore area ratio of the second pores in the second outer surface, the PES filter membrane is ensured to have a larger flow speed, such that the fluid can rapidly pass through the porous membrane, the filtration time is shortened, and the tensile strength is higher, thereby meeting the requirements of practical application.

As a further improvement of the present disclosure, the average pore size change gradient of the filter membrane is 1.5-6 nm/1 μm; and the ratio of the average pore size of the first outer surface to that of the second outer surface is 7-23.

In the present disclosure, the pore sizes of the pores in the filter membrane are changed gradiently along with the thickness, and the pore size is gradually reduced from the large-pore surface to finally the small-pore surface. The ratio of the average pore sizes of the two outer surfaces can be called an asymmetry factor, the smaller value (closer to 1) indicates the stronger symmetry of the two outer surfaces of the filter membrane, and the larger value indicates the stronger asymmetry of the two outer surfaces of the filter membrane. It is found through the measurement that the ratio of the average pore size of the first outer surface to that of the second outer surface is 7-23, preferably 10-20, indicating that the two outer surfaces of the PES filter membrane of the present disclosure are asymmetric, but not highly asymmetric. The asymmetry ensures that the filter membrane has larger flux, longer service life, and high retention efficiency of a virus, thereby meeting the actual requirements.

Since the pore size of the PES filter membrane is changed along with the gradient of the membrane thickness, the change speed of the membrane pore size along with the thickness is reflected by the change gradient of the average pore size in the present disclosure, and the larger value indicates the pore size changes rapidly, and the smaller value indicates the pore size changes slowly. The value can be obtained by (average pore size of first outer surface-average pore size of second outer surface)/thickness with the unit of nm (representing pore size)/1 μm (representing thickness). The average pore size change gradient of the filter membrane in the present disclosure is 1.5-6 nm/1 μm, which is smaller, indicating that the pore size of the membrane in the present disclosure changes along with the thickness in a small gradient manner, the pore size of the membrane does not change too fast, and overlarge pores do not exist (when the pores of the pre-filtering layer are overlarge, the integral mechanical strength of the membrane is too low, and the membrane is not pressure-resistant and easy to damage under the pressure action). Then at this time, the pre-filtering layer can play a certain supporting role on the separation layer, and the whole membrane has a good mechanical strength and pressure resistance, and is not easy to damage under the larger pressure. Besides, the membrane can have the high-efficient retention of a virus, a faster flux, and a larger dirt-holding capacity.

As a further improvement of the present disclosure, the PMI average pore size of the filter membrane is 15-25 nm, the thickness of the filter membrane is 40-150 μm, and the porosity is 70%-85%.

The average pore size of the filter membrane is tested by a PMI pore size tester. The PMI average pore size of the filter membrane of the present disclosure is 15-25 nm. The PES filter membrane is ensured to have a strong retention effect on a nano-scale parvovirus (even a mouse parvovirus with a particle size of 20 nm) through the tortuous path of the main body structure and the certain thickness of the membrane, such that the requirements of practical application can be met and the PES filter membrane is suitable for being used as a virus membrane.

The thickness of the membrane can be measured by performing morphology characterization of the membrane structure by using a scanning electron microscope, performing measurement by using a computer software (such as Matlab, NIS-Elements and the like) or manually, and then performing calculation. Of course, those skilled in the art can obtain the above parameters by other measuring means, and the above measuring means are only used for reference. When the thickness of the membrane is too small, the mechanical strength of the membrane is low. Meanwhile, since the filtering time is too short, effective filtering cannot be performed. When the thickness of the membrane is too large, the filtration time is too long, and the time cost is too large. The thickness of the PES filter membrane of the present disclosure is 40-150 μm, such that the PES filter membrane has high mechanical strength, can perform an effective filtration, has high filtering efficiency, short filtering time, and low time cost.

When the porosity of the membrane is too high, the tensile strength of the membrane is too low, the mechanical performance is poor, the industrial practical value is low, and thus the market demand cannot be met. When the porosity of the membrane is too low, on one hand, the flow speed of the membrane is influenced, such that the filtering speed of the membrane is low, the filtering time is long, and the time cost is high; and on the other hand, the dirt-holding capacity of the membrane is too low, the service life is too short, the membrane needs to be replaced in a short time, and the economic cost is greatly improved. The porosity of the porous membrane in the present disclosure is 70%-85%, such that the membrane has a good tensile strength, also has a high filtering speed, a high flow rate, also high dirt-holding capacity, long service life, and low economic cost, and can retain more impurity particles.

As a further improvement of the present disclosure, the PMI average pore size of the pre-filtering layer is 50-200 nm, the porosity is 75%-93%, and the thickness of the pre-filtering layer accounts for 70%-90% of that of the membrane.

Compared with the separation layer, the pore size of the pores of the pre-filtering layer is larger and the porosity is also larger. It can be found by testing that the PMI average pore size of the pre-filtering layer is 50-200 nm (preferably 60-180 nm), such that the filter membrane has a higher flow speed, and can also play a sufficient role in retaining large-particle impurities (large-particle-size viruses) without influencing the subsequent retention of parvoviruses. The thickness of the pre-filtering layer accounts for 70%-90% of the whole thickness of the membrane, indicating that most regions of the membrane are the pre-filtering layer. Besides, under the combined action of large pore size and high porosity (the porosity of the pre-filtering layer is 75%-93%), the whole membrane has the advantages of high flux, high filtering speed, low time cost, high dirt-holding capacity, and long service life.

The PMI average pore size, porosity, thickness and other parameters of the pre-filtering layer in the present disclosure can be obtained by firstly tearing the PES filter membrane and dividing the membrane into the separation layer and the pre-filtering layer, and then subjecting the pre-filtering layer to a corresponding parameter test; or by performing morphology characterization of a membrane cross-sectional structure by using a scanning electron microscope, then performing measurement by using a computer software (such as Matlab, NIS-Elements and the like) or manually, and performing calculation. Of course, those skilled in the art can obtain the above parameters by other measuring means, and the above measuring means are only used for reference.

As a further improvement of the present disclosure, the pre-filtering layer comprises a skin layer region and a pre-filtering region; one side of the skin layer region comprises the first outer surface, the pore area ratio of the first pores in the first outer surface is smaller than that of the second pores in the second outer surface, and the thickness of the skin layer region is 0.3-3.2 μm; and the pore area ratio of the first pores in the first outer surface is 0.15%-1.5%.

It is found that a region within the pre-filtering layer, a portion of the filter membrane, has a small number of pores inside and very low porosity, and is called the skin layer region, which is on a side, facing away from the separation layer, of the pre-filtering layer. The largest characteristic of the skin layer region is that the number of the pores is very small, and the porosity of the region is low. When the pre-filtering layer of the filter membrane comprises the skin layer region, one side surface, facing away from the separation layer, of the skin layer region, is the first outer surface. At this time, the number of the first pores in the first outer surface is very small. Although the average pore size of the first pores is still larger, the pore area rate of the first pores in the first outer surface is still smaller than that of the second pores in the second outer surface. Besides, the pore area ratio of the first pores in the first outer surface is 0.15%-1.5% through testing. The skin layer region is beneficial to improving the tensile strength of the membrane, and simultaneously provides a supporting and protecting function for the separation layer, such that the whole membrane is more pressure-resistant and not easy to break, and has longer service life. In addition, it is found by the measurement that the thickness of the skin layer region is 0.3-3.2 μm, which is smaller, so as to improve the supporting strength of the membrane and also not influencing the integral filtering speed and dirt-holding capacity of the membrane.

As a further improvement of the present disclosure, the average pore size of the separation layer is 15-25 nm, the porosity is 60%-80%, and the thickness of the separation layer is 2-20 μm.

Compared with the pre-filtering layer, the pore size of the pores of the separation layer is smaller, and the average pore size (PMI average pore size) is 15-25 nm, such that the PES filter membrane has higher retention efficiency on impurities with small particle sizes (particularly a parvovirus with the particle size of 20 nm), meets the requirements of practical application, and is particularly suitable for virus removal.

The thickness of the separation layer is 2-20 μm, such that the retention efficiency of impurities is ensured, the whole membrane is further ensured to have higher flux, high filtering speed, and low time cost. Meanwhile, the porosity of the separation layer is 60%-80%, indicating that the separation layer can play a sufficient retention role on a parvovirus and further prolongs the service life of the membrane.

The average pore size, porosity, thickness and other parameters of the separation layer in the present disclosure can be obtained by firstly tearing the PES filtering membrane and dividing the membrane into the separation layer and the pre-filtering layer, and then subjecting the separation layer to a corresponding parameter test; or by performing morphology characterization of a membrane cross-sectional structure by using a scanning electron microscope, then performing measurement by using a computer software (such as Matlab, NIS-Elements and the like) or manually, and performing calculation. In addition, the thickness of the separation layer can also be obtained by performing a retention test by using a 20-nm colloidal gold as an impurity particle, and the length of a 20-nm colloidal gold retention region in the filter membrane is the thickness of the separation layer. The specific test method can refer to Chinese patent CN105980037B-membrane for removing virus. Of course, those skilled in the art can obtain the above parameters by other measuring means, and the above measuring means are only used for reference.

As a further improvement of the present disclosure, the ratio of the average pore size of the pre-filtering layer to that of the separation layer is (4-13):1.

The main body structure of the PES filter membrane in the present disclosure is mainly divided into two regions, wherein the region with a relatively larger pore size of the pores is the pre-filtering layer, and the region with a relatively smaller pore size of the pores is the separation layer. After measurement, it is found that the ratio of the average pore size of the pre-filtering layer to that of the separation layer is (4-13): 1 (preferably (6-11):1). On one hand, the PES filter membrane of the present disclosure is an asymmetric membrane, and the pore size of the pores changes with the thickness. On the other hand, it is also indicated that the pore size of the membrane of the present disclosure changes with the thickness in a small gradient manner, the pore size of the membrane does not change too rapid, and no overlarge pores exist, such that the PES filter membrane is ensured to have the high-efficiency retention of a virus, a faster flux, and also a large dirt-holding capacity.

As a further improvement of the present disclosure, the pre-filtering layer comprises a first fiber forming a porous structure, and the first fiber is in a sheet structure; the separation layer comprises a second fiber forming a porous structure, and the second fiber is in a strip structure; and the average diameter of the first fiber is greater than that of the second fiber, and the average diameter of the second fiber is 30-75 nm.

In the body structure of the PES filter membrane provided by the present disclosure, it can be clearly seen that the fiber structure is changed along with the membrane thickness, the first fiber in the pre-filtering layer is in a sheet structure, and the second fiber in the separation layer is in a strip structure. The average diameter of the first fiber is larger than that of the second fiber because the pores of the pre-filtering layer are relatively large, the pores formed by the first fibers have high stability and are not easy to collapse or shrink, thereby further guaranteeing the stability of the flow speed of the fluid. Meanwhile, the pre-filtering layer formed by the first fiber of the sheet structure is more stable and pressure-resistant, can play a certain role in supporting and protecting the separation layer, and the sheet fiber structure distribution can help fluid diffusion and improve the retaining effect of the small pores. The separation layer formed by the second fiber with the strip-shaped structure has a proper porosity and pore distribution, such that the whole membrane has higher flow speed and virus-retention efficiency. In addition, the average diameter of the second fiber is 30-75 m, such that the stability of the pores inside the separation layer is ensured, and a parvovirus impurity can be well reserved. The first fiber and the second fiber of the structure and thickness are beneficial to ensuring that the whole membrane has a higher mechanical strength and filtration stability, and can efficiently filter for a long time. Therefore, the PES filter membrane is particularly suitable for the field of virus removal.

The thickness degree of the fiber section can be regarded as the diameter of the fiber. The average diameter of the second fiber in the present disclosure can be obtained by performing morphology characterization of the cross-sectional structure of the filter membrane by using a scanning electron microscope, then performing measurement by using a computer software (such as Matlab, NIS-Elements and the like) or manually, and calculating an average value. Of course, those skilled in the art can obtain the above parameters by other measuring means.

As a further improvement of the present disclosure, the pre-filtering layer further comprises a transition region, the transition region is positioned at one side, close to the separation layer, of the pre-filtering layer, and the continuous fiber forms a porous structure of the transition region and gradually changes from the sheet structure to the strip structure; and one side, close to the separation layer, of the continuous fiber is continuous with one side, close to the pre-filtering layer, of the second fiber.

As a further improvement of the present disclosure, the average pore size of the transition region is 60-170 nm, the porosity is 75%-82%, and the thickness of the transition region is 4-20 μm.

The characteristics of the PES filter membrane in the present disclosure such as membrane pore size, fiber structure and the like are gradually, instead of mutationally, changed along with the thickness, such that the whole membrane has high mechanical strength and tensile strength, thereby meeting the requirements of practical application. A transition region is further arranged on one side, close to the separation layer, of the pre-filtering layer, and the continuous fiber in the transition region forms a porous structure of the transition region, such that the pores with a proper pore size and an excellent porosity are arranged in the transition region. In the direction of the pre-filtering layer facing the separation layer, the continuous fiber gradually changes from the sheet structure to the strip structure. Meanwhile, one side, close to the separation layer, of the continuous fiber is continuous with one side, close to the pre-filtering layer, of the second fiber. The “continuous” means that substantially all the fibers (the continuous fiber and the second fiber) are integrally connected to each other, e.g. integrally formed, without the need for an additional bonding agent and the like to interconnect them, and the fibers in the network cannot be separated from each other unless torn by an external force, thereby also indicating that the PES filter membrane is uniform in material at all positions, namely the whole membrane is made of the PES material, and the material is not changed. The average pore size of the transition zone is 60-170 nm, the porosity is 75%-82%, and the thickness is 4-20 μm. Under the combined action of the three indexes, the filter membrane is ensured to have high trapping capacity of various viruses, flux, filtering speed, and economic benefit.

As a further improvement of the present disclosure, the tensile strength of the PES filter membrane is 5-10 MPa and the elongation at break is 8%-30%; the flux of the PES filter membrane is greater than 600 L*h⁻¹*m⁻²@30 psi; the LRV of a virus impurity by the PES filter membrane is greater than or equal to 4; and the protein yield of the PES filter membrane is greater than or equal to 98%.

Important indexes for evaluating the mechanical strength of the filter membrane are the tensile strength and the elongation at break of the filter membrane. Under certain conditions, the higher tensile strength of the filter membrane indicates a better mechanical strength of the filter membrane. The tensile strength refers to the ability of a membrane to withstand parallel stretching. When tested under a certain condition, the membrane sample is acted by a tensile load until destroyed. The tensile strength and the elongation at break of the membrane can be calculated according to the corresponding maximum tensile load and the change of the size (length) of the membrane sample when the membrane sample is destroyed. The tensile strength and the elongation at break can both be measured by a universal tensile tester. A testing method of the tensile strength is well-known in the art, for example, the procedure for testing the tensile strength is explained in detail in ASTM D790 or ISO178. The tensile strength of the filter membrane is 5-10 MPa and the elongation at break is 8%-30%, indicating that the filter membrane has higher tensile strength and elongation at break, better mechanical performance, and higher industrial practical value, thereby completely meeting the market demand.

The permeation flux, flux for short, is also called a permeation rate, and refers to the substance permeation amount of a filter membrane passing through the unit membrane area in a unit time under a certain working pressure in the separation process. The flux reflects the filtering speed. The higher flux reflects the faster filtering speed of the membrane. When the flux of the PES filter membrane is greater than 600 L*h⁻¹*m⁻²@30 psi, which is large, the filter speed of the filter membrane is high, and thus a fluid can rapidly pass through the filter membrane while the retention efficiency is ensured, the time cost is low, and the economic benefit is high.

The viruses trapped by the present disclosure are mainly various viruses with the particle size of 20 nm or above (such as a mouse parvovirus with the particle size of about 20 nm). It is found by a retention test, the LRVs of the various viruses by the PES filter membrane of the present disclosure are all greater than or equal to 4, indicating that the PES filter membrane has a very high retention efficiency to the viruses and plays a role in sufficiently retaining virus impurities, thereby meeting the requirements of practical application. The protein yield of the PES filter membrane is greater than or equal to 98%, indicating that the effective substance proteins in the fluid are not easy to be adsorbed on the membrane. On one hand, the membrane pores are not blocked, the filter membrane still has a longer service life; and on the other hand, the content change of the effective substance proteins in the fluid is very small, the proteins are not lost basically, and the economic benefit is ensured. The method for testing virus impurities can refer to patents CN105980037B-membrane for virus removal, CN101816898B-ultrafiltration membrane and preparation method for, and CN1759924B-ultrafiltration membrane and preparation method therefor, and the like.

As a further improvement of the present disclosure, the LRV of a virus impurity by the PES filter membrane is greater than or equal to 2.5 and smaller than 4.

In the PES filter membrane prepared by the present disclosure, it is found that the pores of a part of the filter membrane are relatively large, such that the filter membrane has very large flux. However, since the membrane pores are large, the retention efficiency of the filter membrane on the parvovirus is reduced to a certain extent, particularly for the parvovirus with the particle size of about 20 nm. The LVR value of the parvovirus cannot reach 4 (but the LRV value can be more than or equal to 2.5). For the filter membranes, in practical use, double-layer stacking is performed (the LRV values of two stacked membranes are equal, for example, when the LRV of a single-layer membrane is 3, the LRV of a double-layer membrane is 6). Therefore, at this time, the filter membrane can still efficiently and sufficiently retain various parvoviruses with particle size of 20 nm or more, meanwhile has larger flux, and still high protein yield due to the large membrane pores.

In another aspect, the present disclosure further provides a method for preparing the asymmetric PES filter membrane for removing a virus, comprising the following steps:

S1: preparing a membrane-casting solution, and casting the solution on a carrier to form a liquid membrane, wherein the membrane-casting solution comprises the following substances in parts by weight: 15-25 parts of polyether sulfone, 55-90 parts of an organic solvent, and 6-25 parts of a polar additive; and the viscosity of the membrane-casting solution is 5,000-10,000 cps; and

S2: immersing the liquid membrane together with the carrier into a curing solution for at least 10 seconds continuously, wherein the curing solution invades inside the liquid membrane and gradually diffuses inwards, and then the separation layer and the pre-filtering layer are formed by the curing; the surface energy of the curing solution is 22-35 dyne/cm; the curing solution comprises water and a penetration additive with the surface energy smaller than or equal to 35 dyne/cm, and the content of the penetration additive is 25%-70%; and the temperature of the carrier is lower than that of the curing solution.

As a further improvement of the present disclosure, the organic solvent is at least one of butyl lactate, dimethyl sulfoxide, dimethylformamide, caprolactam, methyl acetate, ethyl acetate, N-ethyl pyrrolidone, dimethylacetamide, and N-methyl pyrrolidone; and
the polar additive is a mixture of glycerol, azodimethyl N-2-hydroxybutyl propionamide, and polyvinyl alcohol at a mass ratio of 2:1:1.

As a further improvement of the present disclosure, the penetration additive is at least one of isopropanol, ethanol, and glycol.

As a further improvement of the present disclosure, the temperature of the carrier is at least 5° C. lower than that of the curing solution.

As a further improvement of the present disclosure, the temperature of the curing solution is 25-50° C. and the temperature of the carrier is 0-40° C.

During the preparation of the PES filter membrane of the present disclosure, firstly, a membrane-casting solution is prepared, wherein the membrane-casting solution comprises the PES as a film-forming substance, the organic solvent (used as the solvent the PES material), and the polar additive. The polar additive is the mixture of glycerol, azodimethyl N-2-hydroxybutyl propionamide, and polyvinyl alcohol. The addition of the polyvinyl alcohol can control the viscosity of a system, inhibit the liquid membrane from forming large pores in a phase separation process and effectively improve the stability of the flux of the membrane. Under the synergistic effect of the three substances, the hydrophilicity of the organic solvent can be greatly improved. The polar solvent is more easily dissolved by a coagulating bath through the combined action of the polar solvent and the coagulating bath during the phase separation, such that the PES is more easily separated out and the PES filter membrane with the small-pore size gradient change is easily formed. The viscosity of the prepared membrane-casting solution is 5,000-10,000 cps, and can greatly influence the structure and performance, such as the pore size, the thickness, the flow speed and the like, of the finally formed filter membrane. Such viscosity setting ensures that the finally prepared filter membrane has a proper thickness and obtains an ideal pore size. The viscosity of the membrane-casting solution can be directly obtained by a viscometer. Then the membrane-casting solution is casted on the carrier to form the liquid membrane. The membrane-casting solution of the present disclosure may be casted manually (e.g., manually poured, casted, or spread on a casting surface) or automatically (e.g., poured or otherwise casted on a moving bed). A variety of equipment known in the art can be used for casting. The casting equipment includes, for example, a mechanical coater, including a coating blade, a scraper blade, or a spray/pressurized system. As is known in the art, a variety of casting speeds, such as about 2-6 feet per minute (fpm), are suitable. The specific casting speed depends on the situation.

Then the liquid membrane is immersed into the curing solution along with the carrier continuously for at least 10 s. The phase-separation curing time is preferably 20-60 s. Under the combined action of the proper phase-separation curing time and the membrane-casting solution system, the filter membrane with the ideal pore size can be beneficially obtained. The curing solution invades inside the liquid membrane and gradually diffuses inwards, and then the separation layer and the pre-filtering layer are formed by the curing. In the prior art, the curing solution is generally water, the mutual solubility of the water and an organic solvent is not high, and the phase-separation speed is slow, such that the pore size of the pores formed at a later period of the phase separation is large. It can also be understood that the average pore size of the pre-filtering layer is large and the asymmetry of the filter membrane is strong. In order to accelerate the phase-separation speed in the present disclosure, the surface energy of the curing solution is 22-35 dyne/cm by adjusting the curing solution. The surface energy of the curing solution is close to that of the organic solvent, such that the curing solution and the organic solvent can be quickly dissolved mutually, the PES is quickly separated out from the organic solvent, and then the filter membrane with a pore size small gradient change is formed. The curing solution comprises the conventional water and also the penetration additive with a lower surface energy. The penetration additive can reduce the whole surface energy of the curing solution and further improve the speed of the curing solution invading into the liquid membrane, such that the penetrating speed of the curing solution is increased, the phase-separation speed of the whole membrane is ensured to be higher, large pores are not easy to appear, the asymmetry of the whole membrane is smaller, and the PES filter membrane with the pore small gradient continuous change is easy to form.

In addition, in order to further ensure that the pore size of the pores of the membrane is continuously changed with a small gradient along with the thickness of the membrane, the temperature of the carrier is further arranged to be lower than the temperature of the curing solution in the present disclosure, preferably, the temperature of the carrier is at least 5° C. lower than that of the curing solution, the temperature of the curing solution is preferably controlled to be 25-50° C., and the temperature of the carrier is preferably controlled to be 0-40° C. Such arrangement is due to the fact that the phase-separation speed of the liquid membrane is related to the temperature in addition to an exchange speed between a solvent and a non-solvent, and the large temperature difference can more accelerate the phase-separation speed of the liquid membrane. Since the curing solution firstly invades an air side (the side away from the carrier) of the liquid membrane, then small pores are firstly formed in the air side of the liquid membrane, and then large pores are formed in the carrier side of the liquid membrane. Since the temperatures on both sides of the liquid membrane are different, the temperature on the carrier side of the liquid membrane is lower. The membrane pores are adjusted by the change of the temperature difference. Therefore, although the large holes are formed in the carrier side of the membrane, the pore size is not too large, thereby ensuring that the PES filter membrane with a pore small gradient continuous change is formed.

The beneficial effects of the present disclosure are as follows: the present disclosure provides an asymmetric PES filter membrane for removing a virus, comprising a main body. One surface of the main body is a first outer surface, the first outer surface is a large-pore surface, and the average pore size of the first outer surface is 150-450 nm.

The other surface of the main body is a second outer surface, the second outer surface is a small-hole surface, and the average pore size of the second outer surface is 10-42 nm. The average pore size of the main body continuously changes in a gradient manner from a region on one side close to the first outer surface to a region on one side close to the second outer surface. The pore size of the filter membrane continuously changes in a small gradient with the thickness. The main body comprises a pre-filtering layer and a separation layer for retaining a virus, one side of the pre-filtering layer is the first outer surface, and one side of the separation layer is the second outer surface. The other side of the pre-filtering layer and the other side of the separation layer are in transition with a continuous fiber. The PES filter membrane is prepared by only one membrane-casting solution and integrally formed, does not need to be compounded, and has a relatively simple preparation process. Meanwhile, the prepared PES filter membrane has a strong retention effect on a parvovirus, can also obtain higher protein yield, and has large flux and rapid filtering speed, thereby meeting the requirements of practical application. The PES filter membrane is especially suitable in the field of virus removal. In addition, the present disclosure further provides a method for preparing the filter membrane. The preparation method is convenient, rapid and effective, simple to operate, green and environmentally friendly, and suitable for large-scale popularization.

### BRIEF DESCRIPTION OF THE DRAWINGS

FIG. 1 is a scanning electron microscope (SEM) image of a first outer surface of a PES filter membrane prepared in example 1 at a magnifying power of 500×;

FIG. 2 is an SEM image of a further amplification of the first outer surface of the PES filter membrane prepared in example 1 at a magnifying power of 2,000×;

FIG. 3 is an SEM image of a second outer surface of the PES filter membrane prepared in example 1 at a magnifying power of 50K×;

FIG. 4 is an SEM image of a further amplification of the second outer surface of the PES filter membrane prepared in example 1 at a magnifying power of 100K×;

FIG. 5 is an SEM image of a longitudinal section of the PES filter membrane prepared in example 1 at a magnifying power of 700×;

FIG. 6 is an SEM image of the longitudinal section, close to the second outer surface, of the PES filter membrane prepared in example 1 at a magnifying power of 50K×;

FIG. 7 is an SEM image of the longitudinal section, close to the first outer surface, of the PES filter membrane prepared in example 1 at a magnifying power of 20K×;

FIG. 8 is an SEM image of a further amplification of the longitudinal section, close to the first outer surface, of the PES filter membrane prepared in example 1 at a magnifying power of 50K×;

FIG. 9 is an SEM image of a first outer surface of a PES filter membrane prepared in example 5 at a magnifying power of 5K×;

FIG. 10 is an SEM image of a further amplification of the first outer surface of the PES filter membrane prepared in example 5 at a magnifying power of 10K×;

FIG. 11 is an SEM image of a second outer surface of the PES filter membrane prepared in example 5 at a magnifying power of 5K×;

FIG. 12 is an SEM image of a further amplification of the second outer surface of the PES filter membrane prepared in example 5 at a magnifying power of 10K×;

FIG. 13 is an SEM image of a longitudinal section, close to the second outer surface, of the PES filter membrane prepared in example 5 at a magnifying power of 20×;

FIG. 14 is an SEM image of a further amplification of the longitudinal section, close to the second outer surface, of the PES filter membrane prepared in example 5 at a magnifying power of 50K×;

FIG. 15 is a schematic diagram of a flux testing device of the PES filter membrane of the present disclosure;

FIG. 16 is a schematic diagram of a testing device for testing the retention efficiency of the PES filter membrane of the present disclosure by using colloidal gold;

FIG. 17 is an SEM image of a cross section of a multilayer composite ultrafiltration membrane prepared in patent CN1759924B; and

FIG. 18 is a schematic diagram of a compounding device in the preparation of the multilayer composite ultrafiltration membrane in patent CN1759924B.

### DETAILED DESCRIPTION OF THE EMBODIMENTS

In order to more clearly explain the overall concept of the present application, the following detailed description is given by way of examples. In the following examples, raw materials and equipment for preparing the filter membranes are commercially available, unless otherwise specified. The structural morphologies of the filter membranes are characterized by adopting a scanning electron microscope with the model of S-5500 provided by Hitachi company.

### Example 1

A method for preparing an asymmetric PES filter membrane for removing a virus comprised the following steps:

S1: a membrane-casting solution was prepared and casted on a carrier to form a liquid membrane, wherein the membrane-casting solution comprised the following substances in parts by weight: 20 parts of polyether sulfone, 75 parts of an organic solvent, and 20 parts of a polar additive; the viscosity of the membrane-casting solution was 7,500 cps; the organic solvent was dimethylformamide; and the polar additive was a mixture of glycerol, azodimethyl N-2-hydroxybutyl propionamide, and polyvinyl alcohol at a mass ratio of 2:1:1; and

S2: the liquid membrane together with the carrier was immersed into a curing solution for 40 seconds continuously, the curing solution invaded inside the liquid membrane and gradually diffused inwards, and then the separation layer and the pre-filtering layer were formed by the curing; the curing solution comprised water and isopropanol as a penetration additive, and the content of the penetration additive was 50%; and the temperature of the curing solution was 35° C. and the temperature of the carrier was 20° C.

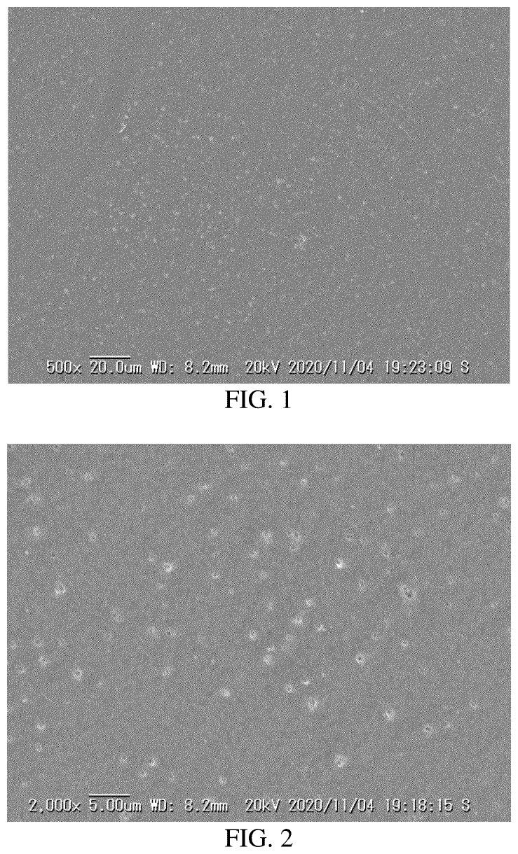

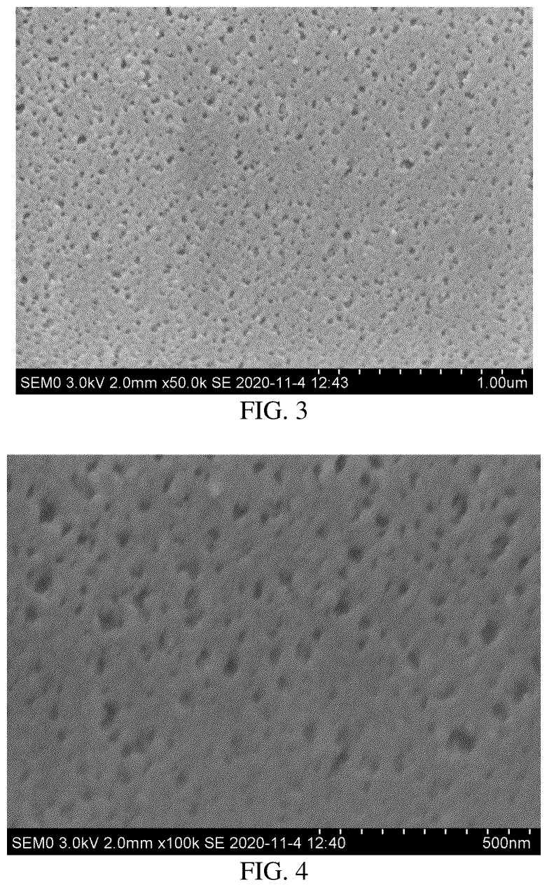

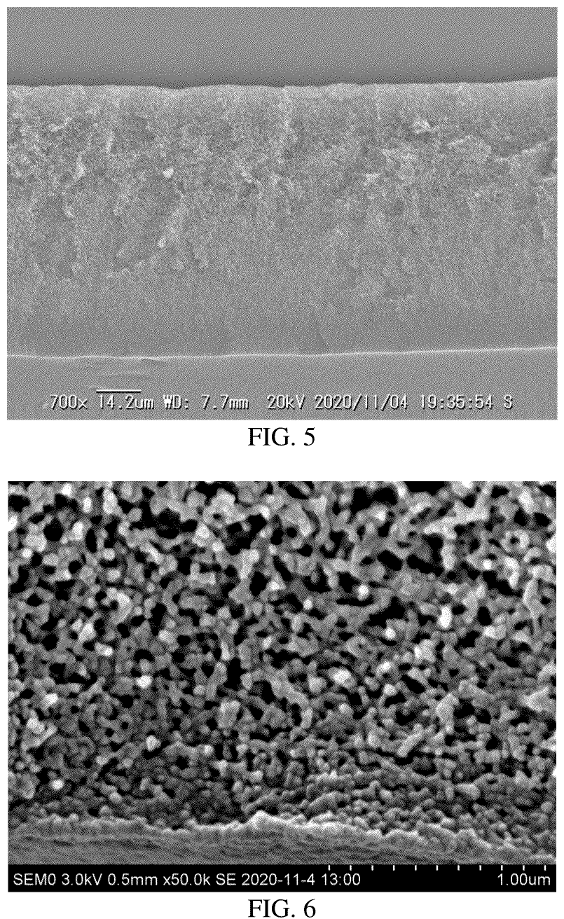

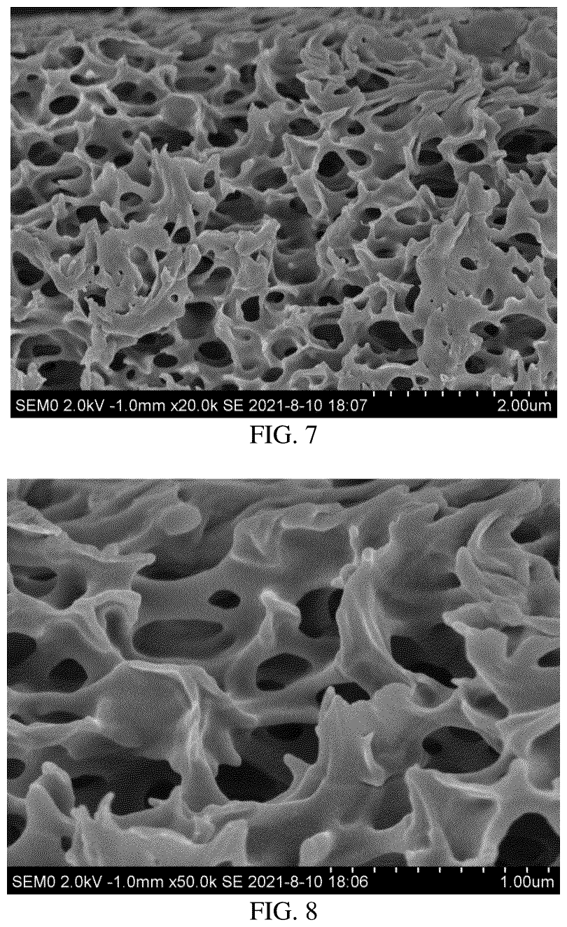

FIG. 1 to FIG. 8 show the PES filter membrane prepared in Example 1, FIG. 1 is a scanning electron microscope (SEM) image of a first outer surface of a PES filter membrane prepared in example 1 at a magnifying power of 500×; FIG. 2 is an SEM image of a further amplification of the first outer surface of the PES filter membrane prepared in example 1 at a magnifying power of 2,000×; FIG. 3 is an SEM image of a second outer surface of the PES filter membrane prepared in example 1 at a magnifying power of 50K×; FIG. 4 is an SEM image of a further amplification of the second outer surface of the PES filter membrane prepared in example 1 at a magnifying power of 100K×; FIG. 5 is an SEM image of a longitudinal section of the PES filter membrane prepared in example 1 at a magnifying power of 700×; FIG. 6 is an SEM image of the longitudinal section, close to the second outer surface, of the PES filter membrane prepared in example 1 at a magnifying power of 50K×; FIG. 7 is an SEM image of the longitudinal section, close to the first outer surface, of the PES filter membrane prepared in example 1 at a magnifying power of 20K×; FIG. 8 is an SEM image of a further amplification of the longitudinal section, close to the first outer surface, of the PES filter membrane prepared in example 1 at a magnifying power of 50K×.

### Example 2

A method for preparing an asymmetric PES filter membrane for removing a virus comprised the following steps:

S1: a membrane-casting solution was prepared and casted on a carrier to form a liquid membrane, wherein the membrane-casting solution comprised the following substances in parts by weight: 21 parts of polyether sulfone, 70 parts of an organic solvent, and 18 parts of a polar additive; the viscosity of the membrane-casting solution was 8,000 cps; the organic solvent was N-ethyl pyrrolidone; and the polar additive was a mixture of glycerol, azodimethyl N-2-hydroxybutyl propionamide, and polyvinyl alcohol at a mass ratio of 2:1:1; and

S2: the liquid membrane together with the carrier was immersed into curing solution for 45 seconds continuously, the curing solution invaded inside the liquid membrane and gradually diffused inwards, and then the separation layer and the pre-filtering layer were formed by the curing; the curing solution comprised water and ethanol as a penetration additive, and the content of the penetration additive was 55%; and the temperature of the curing solution was 30° C. and the temperature of the carrier was 15° C.

### Example 3

A method for preparing an asymmetric PES filter membrane for removing a virus comprised the following steps:

S1: a membrane-casting solution was prepared and casted on a carrier to form a liquid membrane, wherein the membrane-casting solution comprised the following substances in parts by weight: 23 parts of polyether sulfone, 65 parts of an organic solvent, and 16 parts of a polar additive; the viscosity of the membrane-casting solution was 9,000 cps; the organic solvent was N-methyl pyrrolidone; and the polar additive was a mixture of glycerol, azodimethyl N-2-hydroxybutyl propionamide, and polyvinyl alcohol at a mass ratio of 2:1:1; and

S2: the liquid membrane together with the carrier was immersed into a curing solution for 50 seconds continuously, the curing solution invaded inside the liquid membrane and gradually diffused inwards, and then the separation layer and the pre-filtering layer were formed by the curing; the curing solution comprised water and glycol as a penetration additive, and the content of the penetration additive was 60%; and the temperature of the curing solution was 30° C. and the temperature of the carrier was 10° C.

### Example 4

A method for preparing an asymmetric PES filter membrane for removing a virus comprised the following steps:

S1: a membrane-casting solution was prepared and casted on a carrier to form a liquid membrane, wherein the membrane-casting solution comprised the following substances in parts by weight: 15 parts of polyether sulfone, 85 parts of an organic solvent, and 10 parts of a polar additive; the viscosity of the membrane-casting solution was 5,500 cps; the organic solvent was N-ethyl pyrrolidone; and the polar additive was a mixture of glycerol, azodimethyl N-2-hydroxybutyl propionamide, and polyvinyl alcohol at a mass ratio of 2:1:1; and

S2: the liquid membrane together with the carrier was immersed into curing solution for 20 seconds continuously, the curing solution invaded inside the liquid membrane and gradually diffused inwards, and then the separation layer and the pre-filtering layer were formed by the curing; the curing solution comprised water and isopropanol as a penetration additive, and the content of the penetration additive was 35%; and the temperature of the curing solution was 45° C. and the temperature of the carrier was 35° C.

### Example 5

A method for preparing an asymmetric PES filter membrane for removing a virus comprised the following steps:

S1: a membrane-casting solution was prepared and casted on a carrier to form a liquid membrane, wherein the membrane-casting solution comprised the following substances in parts by weight: 17 parts of polyether sulfone, 83 parts of an organic solvent, and 12 parts of a polar additive; the viscosity of the membrane-casting solution was 6,000 cps; the organic solvent was dimethyl sulfoxide; and the polar additive was a mixture of glycerol, azodimethyl N-2-hydroxybutyl propionamide, and polyvinyl alcohol at a mass ratio of 2:1:1; and

S2: the liquid membrane together with the carrier was immersed into a curing solution for 25 seconds continuously, the curing solution invaded inside the liquid membrane and gradually diffused inwards, and then the separation layer and the pre-filtering layer were formed by the curing; the curing solution comprised water and ethanol as a penetration additive, and the content of the penetration additive was 35%; and the temperature of the curing solution was 45° C. and the temperature of the carrier was 35° C.

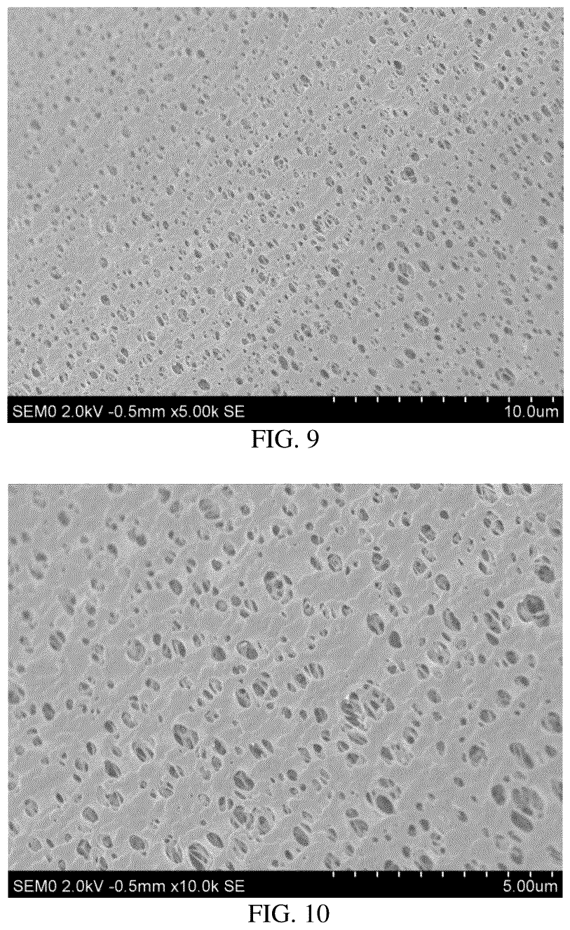

FIG. 9 to FIG. 14 show the PES filter membrane prepared in Example 1,

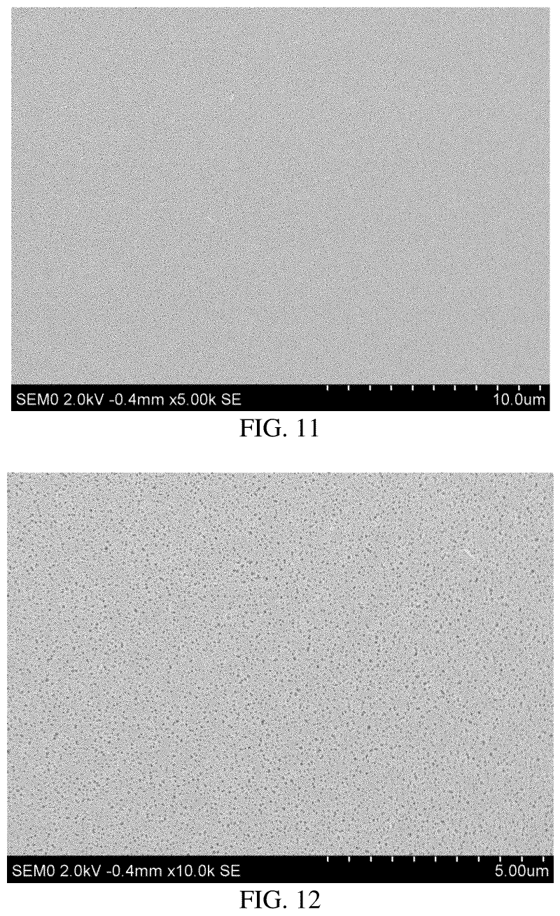

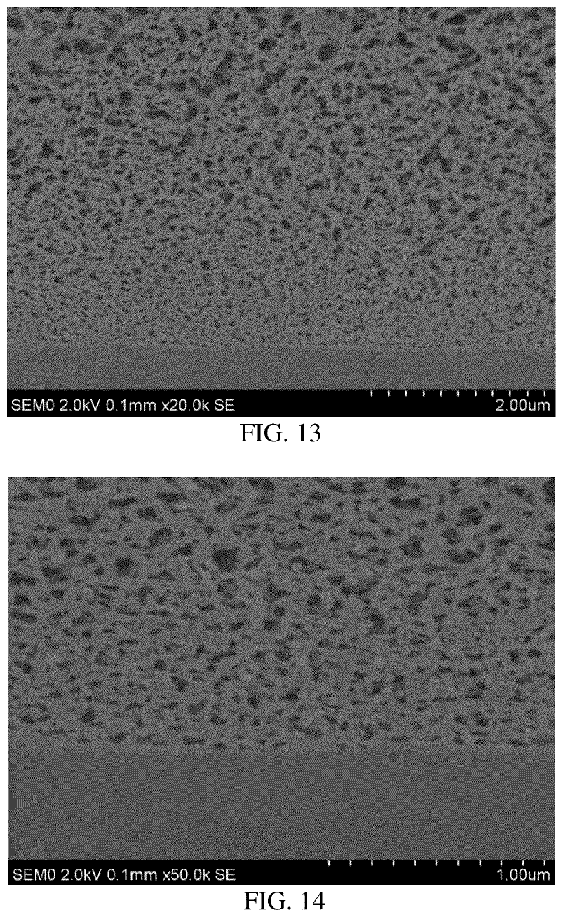

FIG. 9 is an SEM image of a first outer surface of a PES filter membrane prepared in example 5 at a magnifying power of 5K×; FIG. 10 is an SEM image of a further amplification of the first outer surface of the PES filter membrane prepared in example 5 at a magnifying power of 10K×; FIG. 11 is an SEM image of a second outer surface of the PES filter membrane prepared in example 5 at a magnifying power of 5K×; FIG. 12 is an SEM image of a further amplification of the second outer surface of the PES filter membrane prepared in example 5 at a magnifying power of 10K×; FIG. 13 is an SEM image of a longitudinal section, close to the second outer surface, of the PES filter membrane prepared in example 5 at a magnifying power of 20×; FIG. 14 is an SEM image of a further amplification of the longitudinal section, close to the second outer surface, of the PES filter membrane prepared in example 5 at a magnifying power of 50K×;

### Example 6

A method for preparing an asymmetric PES filter membrane for removing a virus comprised the following steps:

S1: a membrane-casting solution was prepared and casted on a carrier to form a liquid membrane, wherein the membrane-casting solution comprised the following substances in parts by weight: 19 parts of polyether sulfone, 81 parts of an organic solvent, and 14 parts of a polar additive; the viscosity of the membrane-casting solution was 7,000 cps; the organic solvent was butyl lactate; and the polar additive was a mixture of glycerol, azodimethyl N-2-hydroxybutyl propionamide, and polyvinyl alcohol at a mass ratio of 2:1:1; and

S2: the liquid membrane together with the carrier was immersed into a curing solution for 30 seconds continuously, the curing solution invaded inside the liquid membrane and gradually diffused inwards, and then the separation layer and the pre-filtering layer were formed by the curing; the curing solution comprised water and glycol as a penetration additive, and the content of the penetration additive was 45%; and the temperature of the curing solution was 35° C. and the temperature of the carrier was 25° C.

### Example 7

A method for preparing an asymmetric PES filter membrane for removing a virus comprised the following steps:

S1: a membrane-casting solution was prepared and casted on a carrier to form a liquid membrane, wherein the membrane-casting solution comprised the following substances in parts by weight: 16 parts of polyether sulfone, 60 parts of an organic solvent, and 9 parts of a polar additive; the viscosity of the membrane-casting solution was 6,800 cps; the organic solvent was dimethylacetamide; and the polar additive was a mixture of glycerol, azodimethyl N-2-hydroxybutyl propionamide, and polyvinyl alcohol at a mass ratio of 2:1:1; and

S2: the liquid membrane together with the carrier was immersed into a curing solution for 55 seconds continuously, the curing solution invaded inside the liquid membrane and gradually diffused inwards, and then the separation layer and the pre-filtering layer were formed by the curing; the curing solution comprised water and ethanol as a penetration additive, and the content of the penetration additive was 40%; and the temperature of the curing solution was 25° C. and the temperature of the carrier was 13ºC.

### Example 8

A method for preparing an asymmetric PES filter membrane for removing a virus comprised the following steps:

S1: a membrane-casting solution was prepared and casted on a carrier to form a liquid membrane, wherein the membrane-casting solution comprised the following substances in parts by weight: 18 parts of polyether sulfone, 70 parts of an organic solvent, and 8 parts of a polar additive; the viscosity of the membrane-casting solution was 6,400 cps; the organic solvent was dimethylsulfoxide; and the polar additive was a mixture of glycerol, azodimethyl N-2-hydroxybutyl propionamide, and polyvinyl alcohol at a mass ratio of 2:1:1; and

S2: the liquid membrane together with the carrier was immersed into a curing solution for 60 seconds continuously, the curing solution invaded inside the liquid membrane and gradually diffused inwards, and then the separation layer and the pre-filtering layer were formed by the curing; the curing solution comprised water and ethanol as a penetration additive, and the content of the penetration additive was 35%; and the temperature of the curing solution was 25° C. and the temperature of the carrier was 15° C.

### Example 9

A method for preparing an asymmetric PES filter membrane for removing a virus comprised the following steps:

S1: a membrane-casting solution was prepared and casted on a carrier to form a liquid membrane, wherein the membrane-casting solution comprised the following substances in parts by weight: 22 parts of polyether sulfone, 80 parts of an organic solvent, and 7 parts of a polar additive; the viscosity of the membrane-casting solution was 7,200 cps; the organic solvent was ethyl acetate; and the polar additive was a mixture of glycerol, azodimethyl N-2-hydroxybutyl propionamide, and polyvinyl alcohol at a mass ratio of 2:1:1; and

S2: the liquid membrane together with the carrier was immersed into a curing solution for 65 seconds continuously, the curing solution invaded inside the liquid membrane and gradually diffused inwards, and then the separation layer and the pre-filtering layer were formed by the curing; the curing solution comprised water and isopropanol as a penetration additive, and the content of the penetration additive was 45%; and the temperature of the curing solution was 20° C. and the temperature of the carrier was 12° C.

### Example 10

A method for preparing an asymmetric PES filter membrane for removing a virus comprised the following steps:

S1: a membrane-casting solution was prepared and casted on a carrier to form a liquid membrane, wherein the membrane-casting solution comprised the following substances in parts by weight: 24 parts of polyether sulfone, 90 parts of an organic solvent, and 6 parts of a polar additive; the viscosity of the membrane-casting solution was 7,400 cps; the organic solvent was N-ethyl pyrrolidone; and the polar additive was a mixture of glycerol, azodimethyl N-2-hydroxybutyl propionamide, and polyvinyl alcohol at a mass ratio of 2:1:1; and

S2: the liquid membrane together with the carrier was immersed into a curing solution for 70 seconds continuously, the curing solution invaded inside the liquid membrane and gradually diffused inwards, and then the separation layer and the pre-filtering layer were formed by the curing; the curing solution comprised water and isopropanol as a penetration additive, and the content of the penetration additive was 40%; and the temperature of the curing solution was 20° C. and the temperature of the carrier was 15° C.

### I Structural Characterization

The structures of the nanoscale polymer filter membranes obtained in each example were subjected to morphology characterization by using a scanning electron microscope, then required data was obtained, and the specific results were shown in the following table:

TABLE 1

| | | | | Area ratio | | |
|---|---|---|---|---|---|---|
| | Average | Area ratio | Average | of second | Ratio of average | Average |
| | pore size | of first | pore size | pores in | pore size of first | pore size |
| | of first | pores in | of second | second | outer surface to | change |
| | outer | first outer | outer | outer | that of second | gradient |
| | surface/nm | surface/% | surface/nm | surface/% | outer surface | nm/1 μm |
| Example 1 | 310 | 1.1 | 24.5 | 9.1 | 12.65 | 3.36 |
| Example 2 | 350 | 0.9 | 30 | 8.6 | 11.67 | 3.20 |
| Example 3 | 390 | 0.6 | 34 | 7.3 | 11.47 | 3.24 |
| Example 4 | 200 | 8.7 | 18.2 | 6.9 | 10.99 | 3.64 |
| Example 5 | 230 | 10.6 | 20.6 | 8.4 | 11.17 | 3.49 |
| Example 6 | 260 | 12.4 | 22.1 | 8.9 | 11.76 | 3.40 |
| Example 7 | 400 | 12.5 | 32 | 8.6 | 12.50 | 8.18 |
| Example 8 | 410 | 13.1 | 34 | 9.0 | 12.06 | 8.17 |
| Example 9 | 430 | 13.6 | 35 | 9.3 | 12.29 | 8.23 |
| Example 10 | 440 | 14.2 | 36 | 9.6 | 12.22 | 8.08 |

TABLE 2
Main body of PES filter membrane

| | | | PMI average |
|---|---|---|---|
| | Thickness/μm | Porosity/% | pore size/nm |
| Example 1 | 85 | 76.2 | 20.7 |
| Example 2 | 100 | 75.7 | 21.6 |
| Example 3 | 110 | 74.4 | 22.8 |
| Example 4 | 50 | 77.5 | 16.4 |
| Example 5 | 60 | 79.2 | 18.3 |
| Example 6 | 70 | 81.3 | 19.1 |
| Example 7 | 45 | 80.5 | 23.5 |
| Example 8 | 46 | 81.7 | 24 |
| Example 9 | 48 | 82.3 | 24.5 |
| Example 10 | 50 | 83.1 | 25 |

TABLE 3
Separation layer and pre-filtering layer

| | | | | Separation layer | | | |
|---|---|---|---|---|---|---|---|
| | Pre-filtering layer | | | | | | Average |
| | | | PMI | | | PMI | diameter |
| | | | average | | | average | of |
| | Thickness/ | Porosity/ | pore | Thickness/ | Porosity/ | pore | second |
| | nm | % | size/nm | nm | % | size/nm | fiber/nm |
| Example 1 | 73 | 77.6 | 105 | 12 | 70.4 | 21 | 53.5 |
| Example 2 | 86 | 76.8 | 130 | 14 | 68.5 | 22 | 58.2 |
| Example 3 | 94 | 75.9 | 140 | 16 | 66.2 | 23 | 61.3 |
| Example 4 | 44 | 78.2 | 70 | 6 | 72.1 | 17 | 42.8 |
| Example 5 | 52 | 81.1 | 80 | 8 | 74.8 | 19 | 47.6 |
| Example 6 | 60 | 83.4 | 90 | 10 | 75.7 | 20 | 50.4 |

TABLE 4
Transition region and skin layer region

| | | | PMI average | |
|---|---|---|---|---|
| | Thickness of | Porosity of | pore size of | Thickness of |
| | transition | transition | transition | skin layer |
| | region/μm | region/% | region/nm | region/μm |
| Example 1 | 13 | 77.1 | 115 | 0.8 |
| Example 2 | 16 | 76.2 | 140 | 1.4 |
| Example 3 | 18 | 75.4 | 150 | 2.6 |
| Example 4 | 6 | 77.5 | 80 | / |
| Example 5 | 8 | 79.2 | 90 | / |
| Example 6 | 10 | 80.1 | 100 | / |

It can be seen from Tables 1-4 that the PES filter membranes prepared in examples 1-6 of the present disclosure all had ideal structures. The filter membranes were integrally formed without a compounding process, and the process preparation was simple. Besides, the PES filter membranes were asymmetric, the pore sizes of the membrane pores changed along with the thickness in a small gradient manner, and no extra-large pores existed. Therefore, the filter membranes had the high-efficiency retention of viruses, the high flux, and were suitable for virus removal.

### Performance Characteristics

The membrane flux was calculated as follows:

calculation formula of membrane flux (J): J=V/(T×A), wherein

J-membrane flux unit: L*h⁻¹*m⁻²

V-sampling volume (L); T-sampling time (h); and A-effective area of membrane (m²)

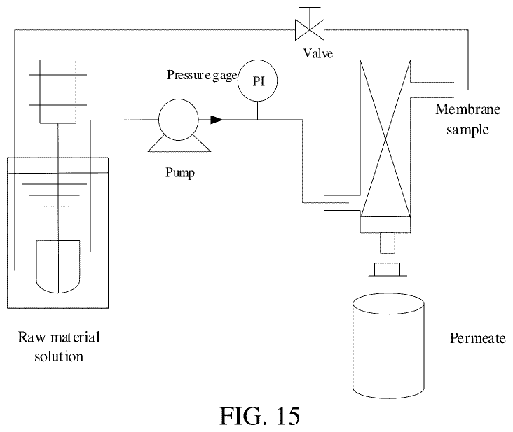

The separation performance of the PES filter membranes was measured by using the following operating conditions: a feed liquid was deionized water, the operating pressure was 30 psi, the operating temperature was 25° C., and the pH of the solution was 7. The flux testing device was shown in FIG. 15.

| | Tensile | Elongation at | Flux/ |
|---|---|---|---|
| | strength/MPa | break/% | L*h⁻¹*m⁻²@30 psi |
| Example 1 | 7.5 | 19 | 1000 |
| Example 2 | 8.5 | 15 | 840 |
| Example 3 | 9.5 | 11 | 700 |
| Example 4 | 5.5 | 27 | 1320 |
| Example 5 | 6 | 25 | 1240 |
| Example 6 | 6.5 | 23 | 1160 |
| Example 7 | 5.4 | 22 | 1500 |
| Example 8 | 5.3 | 24 | 1520 |
| Example 9 | 5.2 | 26 | 1560 |
| Example 10 | 5.1 | 28 | 1600 |

It can be seen from the above table that the samples prepared in examples 1-10 all had good mechanical performances (high tensile strength and elongation at break), were suitable for various processing treatments and convenient to handle, and had high practicability, good flux, and high filtering speed.

In addition, a virus retention test can be performed according to a test method used in the 114th paragraph of CN201010154974.7-ultrafiltration membrane and preparation method therefore.

The used virus was a mouse parvovirus with the particle size of 20 nm.

After testing, it was found that the LRVs of virus impurities with a particle size of 20 nm by the PES filter membranes prepared in examples 1-6 were greater than or equal to 4, thereby indicating that the PES filter membranes of the present disclosure had sufficient retention for the viruses with a particle size of 20 nm or more. Besides, the protein yield of the PES filter membranes were greater than or equal to 98%. Therefore, the PES filter membranes were particularly suitable for virus removal.

However, it was tested that the LRV value of example 7 was 3.5, the LRV value of example 8 was 3, the LRV value of example 9 was 2.7, and the LRV value of example 10 was 2.5, which were all less than 4. During practical use, two filter membranes can be used by stacking, that is, two PES filter membranes of the same LRV value can be stacked together, and then the LRV value of the whole module was at least greater than or equal to 5, thereby meeting requirements of practical application. At the same time, the filter membranes also had good flux, protein yield, and economic benefit.

Filtering precision testing: the retention efficiencies of the PES filter membranes obtained in each example were tested; and retaining particles were colloidal gold with a particle size of 20 nm.

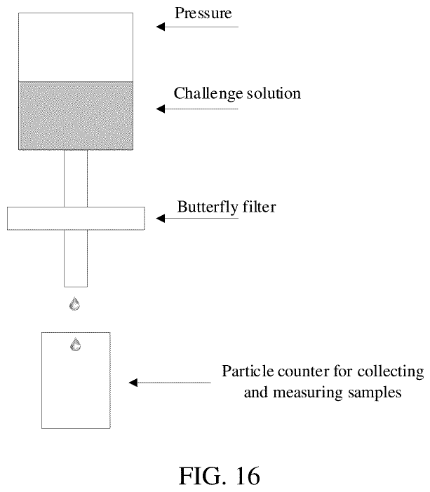

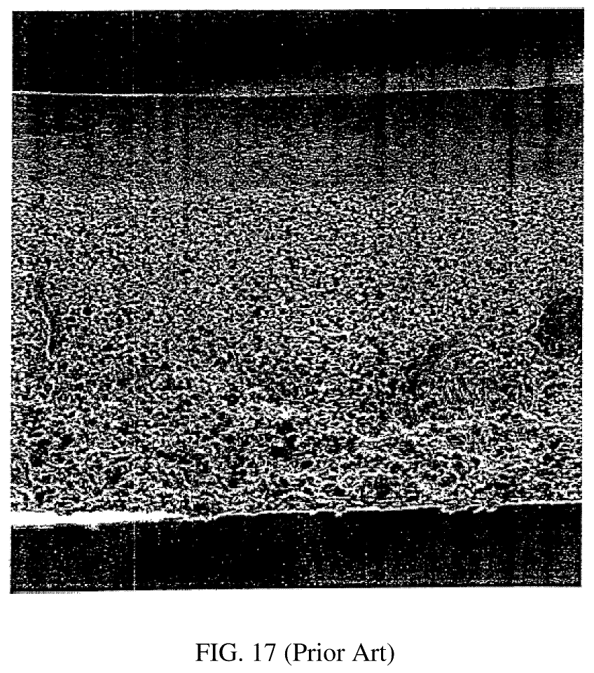

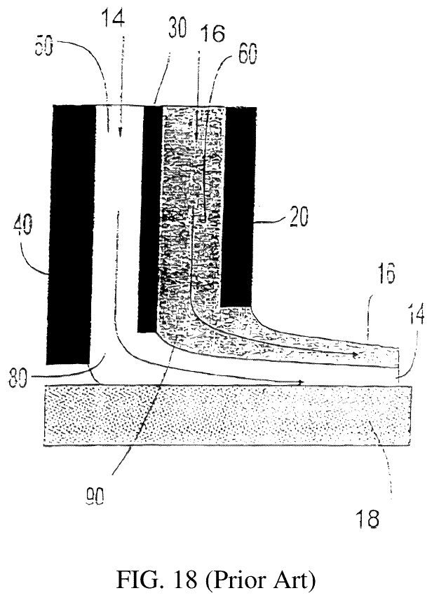

Experimental equipment: a Tianjin Logan particle counter KB-3. Experimental preparation: the experimental equipment was assembled as shown in FIG. 16, ensured to be clean, and rinsed with ultra-pure water. A filter membrane with the diameter of 47 mm was taken and arranged in a butterfly-shaped filter so as to ensure that the air tightness of the assembled filter was good.

### Experimental Steps:

a challenge solution (test liquid) was poured into a storage tank, exhausting of the butterfly filter should be noticed, the butterfly filter was pressurized to 10 kPa, and a downstream filtrate of the butterfly filter was taken using a clean bottle.

The number of particles in the filtrate and the stock solution was measured using the particle counter.

Retention efficiency:

$$η = ( 1 - \frac{{n}_{1}}{{n}_{0}} ) \times 100 \%$$

wherein

η-retention efficiency, %;

n₀-number of particles in the stock solution, average value of 5 sets of counts; and

n₁-number of particles in the filtrate, average value of 5 sets of counts.

After the testing, it was found that the retention efficiencies of the 20-nm colloidal gold by examples 1-6 were greater than or equal to 99.99%.

The foregoing descriptions are only preferred implementations of the present disclosure, and the scope of the present disclosure is not limited to the foregoing examples. All technical solutions based on the idea of the present disclosure fall within the protection scope of the present disclosure. It should be noted that those of ordinary skill in the art can make several improvements and modifications without departing from the principles of the present disclosure. These improvements and modifications should also be considered as falling within the protection scope of the present disclosure.

What is claimed is:

1. An asymmetric polyether sulfone (PES) filter membrane for removing a virus, comprising a main body having a non-directional tortuous path therein, one surface of the main body being a first outer surface, and the other surface of the main body being a second outer surface, wherein the average pore size of the first outer surface is 150-450 nm, and the average pore size of the second outer surface is 10-42 nm;
the average pore size of the main body continuously changes in a gradient manner from a region on one side close to the first outer surface to a region on one side close to the second outer surface; and
the main body comprises a pre-filtering layer and a separation layer for retaining a virus, one side of the pre-filtering layer is the first outer surface, and one side of the separation layer is the second outer surface; and the other side of the pre-filtering layer and the other side of the separation layer are in transition with a continuous fiber.

2. The asymmetric PES filter membrane for removing a virus according to claim 1, wherein a plurality of first pores in a circular shape are arranged in the first outer surface; and the pore area ratio of the first pores in the first outer surface is 0.1%-15%; and
a plurality of second pores in a circular shape are arranged in the second outer surface; and the pore area ratio of the second pores in the second outer surface is 2%-10%.

3. The asymmetric PES filter membrane for removing a virus according to claim 1, wherein the average pore size change gradient of the filter membrane is 1.5-6 nm/1 μm; and
the ratio of the average pore size of the first outer surface to that of the second outer surface is 7-23.

4. The asymmetric PES filter membrane for removing a virus according to claim 1, wherein the PMI average pore size of the filter membrane is 15-25 nm, the thickness of the filter membrane is 40-150 μm, and the porosity is 70%-85%.

5. The asymmetric PES filter membrane for removing a virus according to claim 1, wherein the PMI average pore size of the pre-filtering layer is 50-200 nm, the porosity is 75%-93%, and the thickness of the pre-filtering layer accounts for 70%-90% of that of the membrane.

6. The asymmetric PES filter membrane for removing a virus according to claim 1, wherein the pre-filtering layer comprises a skin layer region and a pre-filtering region; one side of the skin layer region comprises the first outer surface, the pore area ratio of the first pores in the first outer surface is smaller than that of the second pores in the second outer surface, and the thickness of the skin layer region is 0.3-3.2 μm; and the pore area ratio of the first pores in the first outer surface is 0.15%-1.5%.

7. The asymmetric PES filter membrane for removing a virus according to claim 1, wherein the average pore size of the separation layer is 15-25 nm, the porosity is 60%-80%, and the thickness of the separation layer is 2-20 μm.

8. The asymmetric PES filter membrane for removing a virus according to claim 1, wherein the ratio of the average pore size of the pre-filtering layer to that of the separation layer is (4-13):1.

9. The asymmetric PES filter membrane for removing a virus according to claim 1, wherein the pre-filtering layer comprises a first fiber forming a porous structure, and the first fiber is in a sheet structure; the separation layer comprises a second fiber forming a porous structure, and the second fiber is in a strip structure; and the average diameter of the first fiber is greater than that of the second fiber, and the average diameter of the second fiber is 30-75 nm.

10. The asymmetric PES filter membrane for removing a virus according to claim 9, wherein the pre-filtering layer further comprises a transition region, the transition region is positioned at one side, close to the separation layer, of the pre-filtering layer, and the continuous fiber forms a porous structure of the transition region and gradually changes from the sheet structure to the strip structure; and one side, close to the separation layer, of the continuous fiber is continuous with one side, close to the pre-filtering layer, of the second fiber.

11. The asymmetric PES filter membrane for removing a virus according to claim 10, wherein the average pore size of the transition region is 60-170 nm, the porosity is 75%-82%, and the thickness of the transition region is 4-20 μm.

12. The asymmetric PES filter membrane for removing a virus according to claim 1, wherein the tensile strength of the PES filter membrane is 5-10 MPa and the elongation at break is 8%-30%;
the flux of the PES filter membrane is greater than 600 L*h⁻¹*m⁻²@30 psi;
the LRV of a virus impurity by the PES filter membrane is greater than or equal to 4; and
the protein yield of the PES filter membrane is greater than or equal to 98%.

13. The asymmetric PES filter membrane for removing a virus according to claim 1, wherein the LRV of a virus impurity by the PES filter membrane is greater than or equal to 2.5 and smaller than 4.

14. A method for preparing the asymmetric PES filter membrane for removing a virus according to claim 1, comprising the following steps:
S1: preparing a membrane-casting solution, and casting the solution on a carrier to form a liquid membrane, wherein the membrane-casting solution comprises the following substances in parts by weight: 15-25 parts of polyether sulfone, 55-90 parts of an organic solvent, and 6-25 parts of a polar additive; and the viscosity of the membrane-casting solution is 5,000-10,000 cps; and
S2: immersing the liquid membrane together with the carrier into a curing solution for at least 10 seconds continuously, wherein the curing solution invades inside the liquid membrane and gradually diffuses inwards, and then the separation layer and the pre-filtering layer are formed by the curing; the surface energy of the curing solution is 22-35 dyne/cm; the curing solution comprises water and a penetration additive with the surface energy smaller than or equal to 35 dyne/cm, and the content of the penetration additive is 25%-70%; and the temperature of the carrier is lower than that of the curing solution.

15. The method for preparing the asymmetric PES filter membrane for removing a virus according to claim 14, wherein the organic solvent is at least one of butyl lactate, dimethyl sulfoxide, dimethylformamide, caprolactam, methyl acetate, ethyl acetate, N-ethyl pyrrolidone, dimethylacetamide, and N-methyl pyrrolidone; and
the polar additive is a mixture of glycerol, azodimethyl N-2-hydroxybutyl propionamide, and polyvinyl alcohol at a mass ratio of 2:1:1.

16. The method for preparing the asymmetric PES filter membrane for removing a virus according to claim 14, wherein the penetration additive is at least one of isopropanol, ethanol, and glycol.

17. The method for preparing the asymmetric PES filter membrane for removing a virus according to claim 14, wherein the temperature of the carrier is at least 5° C. lower than that of the curing solution.

18. The method for preparing the asymmetric PES filter membrane for removing a virus according to claim 17, wherein the temperature of the curing solution is 25-50° C. and the temperature of the carrier is 0-40° C.
